(19) United States
(12) Patent Application Publication
(10) Pub. No.: US 2006/0256584 A1
(43) Pub. Date: Nov. 16, 2006

(54) APPARATUS FOR ILLUMINATING OBJECTS AND MOUNTING WORKS OF ART

(75) Inventor: JOHN J. PAOLUCCIO, Modesto, CA (US)

Correspondence Address: ROBERT S. SMITH, 1131-0 TOLLAND TURNPIKE, SUITE 306, MANCHESTER, CT, 06040, US

(73) Assignee: FAN-FI INTERNATIONAL, INC. DBA ENERGY TECHNOLOGY LABORATORIES, MODESTO, CA (US)

(21) Appl. No.: 10/908,516

(22) Filed: May 16, 2005

(51) Int. Cl. H01R 33/00

(52) U.S. Cl. 362/652; 362/656; 362/191

(57) ABSTRACT

A lighting fixture which includes a base module having first and second connectors, the connectors been selected from the group that consists of male and female connectors. The apparatus also includes at least first and second lighting modules each having male and female connectors. At least one of the connectors on each of the first and second lighting modules is dimensioned and configured for engagement with a connector on the base module; each lighting module includes a light emitting diode, each of the male connectors is dimensioned configured for mating engagement with each of the female connectors to provide an electrical connection and a physical mounting limiting relative movement between respective modules having mating connectors. In some form to the invention the connectors are dimensioned configured whereby mating male and female connectors that are part of respective modules allow relative rotation therebetween. Both the lighting modules in the base module may be cylindrical. The lighting modules may include a bullet housing. The invention also includes a bracket for mounting an associated framed artistic work having a mounting wire that is generally horizontal when the artistic work is normally viewed which includes a base; a hook depending from the base, the hook being mounted to allow movement toward and away from the base whereby the hook can engage the mounting wire and raised the artistic work into engagement with the base. In some embodiments the bracket has a substantially L-shaped form that is dimensioned in configured for engaging the top and back of an associated framed artistic work and the apparatus further includes a locking mechanism to prevent movement of the hook to release the associated mounting wire of the associated artistic work.

### FIELD OF THE INVENTION

The invention has application to methods and apparatus for providing illumination to display works of art including, but not limited to paintings and the like. A particular application of the methods and apparatus of the present invention is the lighting of framed paintings and pictures that hang on a wall as in homes, businesses, art galleries, libraries and museums.

### BACKGROUND OF THE INVENTION

The use of picture lights to enhance the visual colors and content of framed wall hung pictures and paintings are well known. Room lighting alone is generally insufficient for properly displaying wall hung framed pictures. Frequently track lighting is used and more recently light fixtures that attach to the top or bottom of the frame. The light bulbs may be of many types but many can cause harm to the picture or painting due to heat from the light or the light wave length.

Previous methods of enhancing the lighting involved measuring the painting and selecting a different light fixture for different size pictures. This method is not very satisfactory because frequently, after the fixture is mounted in the frame it become clear that a larger or smaller fixture would have been preferred. In addition, when one has numerous pictures or art work to display, it is very cumbersome and inefficient to purchase, store and try to fit each picture to the proper width light fixture.

At present virtually all prior art picture lights use a fixed width light fixture to serve a range of picture frame sizes. The fixtures are generally provided in a range of widths such as 8″, 12″, 16″, 24″, etc. The light bulbs are fixed and the frame support is generally bent to a standard pre-selected angle.

The selection of fixed size lighting fixtures to serve specific size pictures is inefficient, costly and one generally has to compromise the picture lighting quality to accommodate the selected width light fixture. Even when the support arm light that holds the light fixture is bent or formed to the desired angle all the light ray angles are at the same selected angle. This does not bring out the best visual presentation for the viewer.

### SUMMARY OF THE INVENTION

It is an object of the present invention to provide lighting that will enhance the appearance of objects such as works of art that are framed which, more particularly provide a proper task lighting level, intensity, and adjustability to serve the lighting requirements for any wall hung picture, painting or art work with one apparatus in accordance with the present invention.

Another object of the present invention is to provide lighting that will not harm objects such as valuable and historic works of art.

A further object of the present invention is to provide lighting that may be easily oriented to focus on the object being illuminated.

Still another object to the present invention is to provide illumination for objects that consumes minimal energy.

Yet another object of the present invention is to provide illumination that can readily be adjusted to suit the illumination requirements of a particular object by sequentially evaluating multiple possibilities.

Another object of the present invention is to provide a method and apparatus that allows the consumer great flexibility in varying the illumination choices for an object each while not requiring a consumer to utilize a large variety of unique parts or to maintain a large inventory of unique parts.

An additional object of the present invention is to provide a method and apparatus that will enable the user to readily alter the method and apparatus based on the physical dimensions of the object being illuminated.

It has now been found that these and other object invention may be attained in a lighting fixture which includes a base module having first and second connectors, the connectors been selected from the group that consists of male and female connectors. The apparatus also includes at least first and second lighting modules each having male and female connectors. At least one of the connectors on each of the first and second lighting modules is dimensioned and configured for engagement with a connector on the base module; each lighting module includes a light emitting diode, each of the male connectors is dimensioned configured for mating engagement with each of the female connectors to provide an electrical connection and a physical mounting limiting relative movement between respective modules having mating connectors.

In some form to the invention the connectors are dimensioned configured whereby mating male and female connectors that are part of respective modules allow relative rotation therebetween. Both the lighting modules in the base module may be cylindrical. The lighting modules may include a bullet housing.

Some forms of the apparatus include a battery for operating one or more light emitting diodes in the lighting modules. That battery may be a rechargeable battery in the apparatus may further include a solar collector for recharging the rechargeable battery. The light from the lighting modules has a color and the color is produced selecting from the group which consists of (1) light emitting diodes that produce colored light and (2) light emitting diodes that produce light that passes through a lens having a color.

Some embodiments of the present invention include a bracket for engaging a framed artistic work, the bracket supporting the base module and at least first and second lighting modules. The bracket may include a support bar extending to the base module. The bracket may be adapted for mounting an associated framed artistic work having a mounting wire that is generally horizontal when the artistic work is normally viewed and the bracket may include a base; a hook depending from the base and the hook is mounted to allow movement toward and away from the base whereby the hook can engage the mounting wire and raise the artistic work into engagement with the base. In some embodiments the bracket has a substantially L-shaped form that is dimensioned and configured for engaging the top and back of the associated framed artistic work. In some embodiments the apparatus also includes a locking mechanism to prevent movement of the hook to release the associated mounting wire of the associated artistic work. Suddenly, the bracket may include a plate that is disposed in substantially vertical orientation during normal installation and the plate includes at least two openings for use by associated fasteners to secure the bracket to an associated wall. At least one of the openings may be elongated to facilitate leveling of the bracket.

The invention also includes a bracket for mounting an associated framed artistic work having a mounting wire that is generally horizontal when the artistic work is normally viewed which includes a base; a hook depending from the base, the hook being mounted to allow movement toward and away from the base whereby the hook can engage the mounting wire and raised the artistic work into engagement with the base. In some embodiments the bracket has a substantially L-shaped form that is dimensioned in configured for engaging the top and back of an associated framed artistic work and the apparatus further includes a locking mechanism to prevent movement of the hook to release the associated mounting wire of the associated artistic work. In some embodiments the bracket includes a plate that is disposed in substantially vertical orientation during normal installation and the plate includes at least two openings for use by associated fasteners to secure the bracket to an associated wall and one of the openings is elongated to facilitate leveling of the bracket.

### BRIEF DESCRIPTION OF THE DRAWING

The invention will be better understood by reference to the accompanying drawing in which:

FIG. 1 is a schematic view of one form of the apparatus in accordance with the present invention cooperating with a framed picture.

FIG. 2A is a schematic enlarged side view of the apparatus illustrated in FIG. 1.

FIG. 2B is a diagrammatic view illustrating an adjustment hook attached to a picture.

FIG. 2C is a diagrammatic view illustrating the adjustment hook tightened to raise picture frame to bracket.

FIG. 3 is a plan view of the lighting apparatus illustrated in FIG. 1.

FIG. 4 is an exploded view of a starter module and a plurality of snap-in modules that are part of the lighting apparatus illustrated in FIG. 1.

FIG. 5A is an enlarged schematic view of an individual snap-in module.

FIG. 5B is an enlarged schematic view of the internal components of an individual snap-in module with a fixed LED.

FIG. 5C is an enlarged schematic view of the male connection port.

FIG. 5D is an enlarged schematic view of the female connection port and FIG. 5E is an enlarged schematic view of the individual snap-in module with a bullet light housing.

FIG. 6 is a schematic wiring diagram of the components of the lighting apparatus illustrated in FIG. 1.

### DESCRIPTION OF THE PREFERRED EMBODIMENTS

LED's use very little energy, produce very little heat and the wave length does not injure, even, fine paintings or samplers or other delicate textile or other art work. This invention not only uses low energy LED lights that are battery operated; it allows each LED to be independently rotated to provide infinite adjustability. Thus, this allows the lights to be set at any angle to obtain the ideal visual effect for any art work, framed picture or painting, sculpture, glassware or cabinet display where lighting is desired. Prior art lighting systems used too much energy to effectively display many items in items like china cabinets. The present invention will beneficially display art, figurines, dolls, and pictures and achieve a multitude of other tasks with infinite adjustment and simple add on light elements.

This invention pertains to task lighting fixtures for wall hung pictures and artwork. More particularly, the invention pertains to low energy consuming LED type light fixtures that are battery operated to avoid unsightly wires that would not be practical for wall hung pictures. In addition, this invention has unique snap-in light modules 20 that are used to increase or decrease the width of the overall light fixture. The snap-in modules 20 allow for instant changes in the width of the fixture. Although the term “snap-in module” is used herein, it will be understood that other embodiments may use threaded connectors to couple the so-called snap-in modules and the base or starter module 19.

The snap-in modules may be quickly and independently rotated to cause the light ray angles to be directed directly where desired. The control circuit and battery package may be placed on the frame support bracket and located behind the picture. The extension support bar between the frame support bracket and the snap-in light modules, in a preferred embodiment, is 6″, 10″ or any length necessary for the object to which illumination is being provided. It may be fixed, flexible or curved for esthetic purposes. A friction hinge may be provided to adjust angle of support bar.

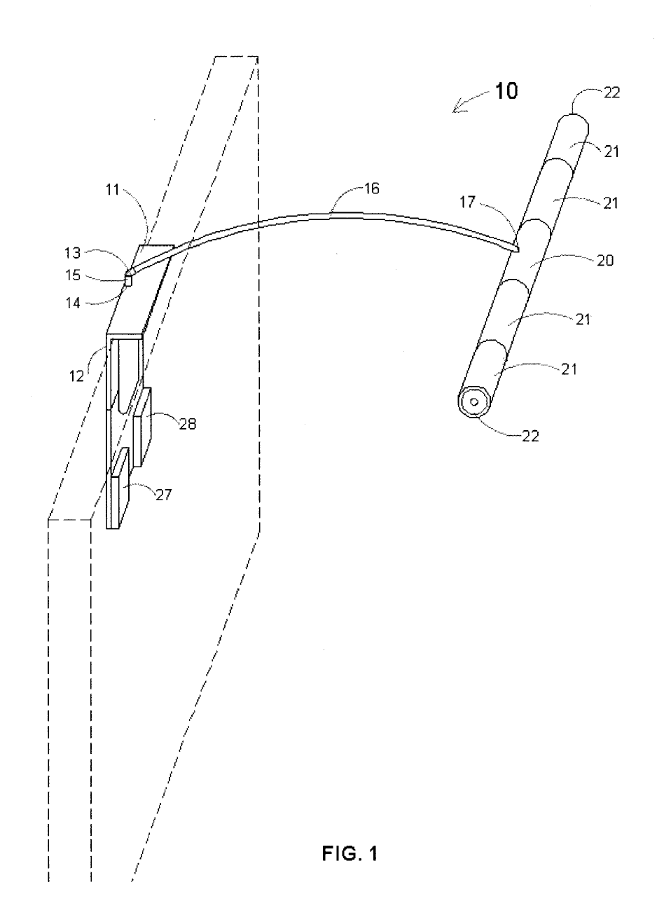

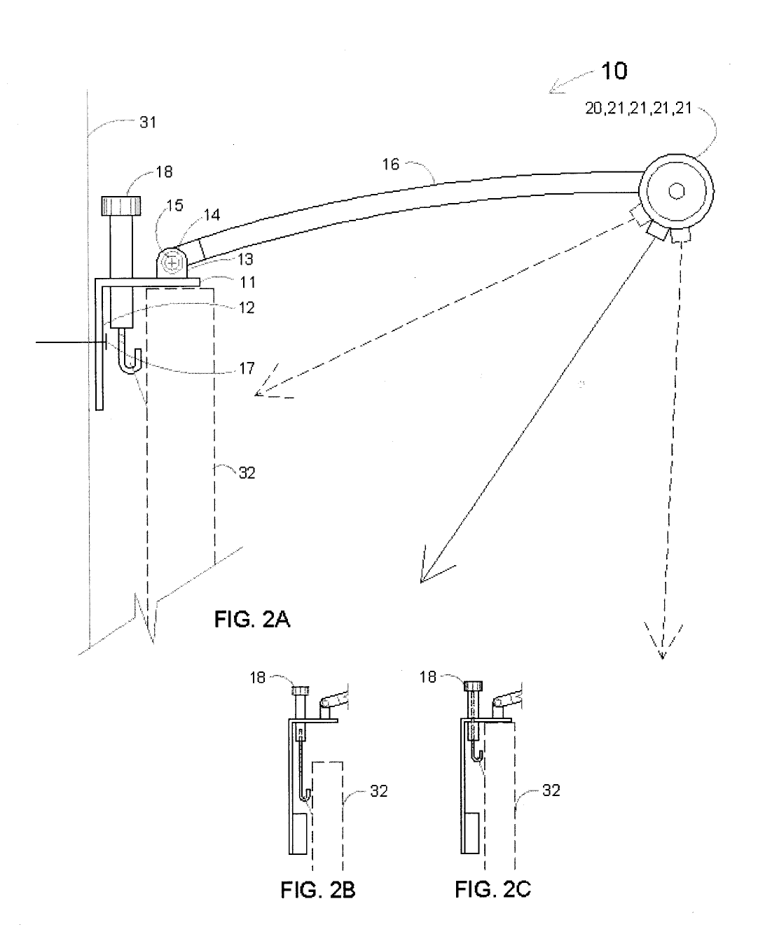

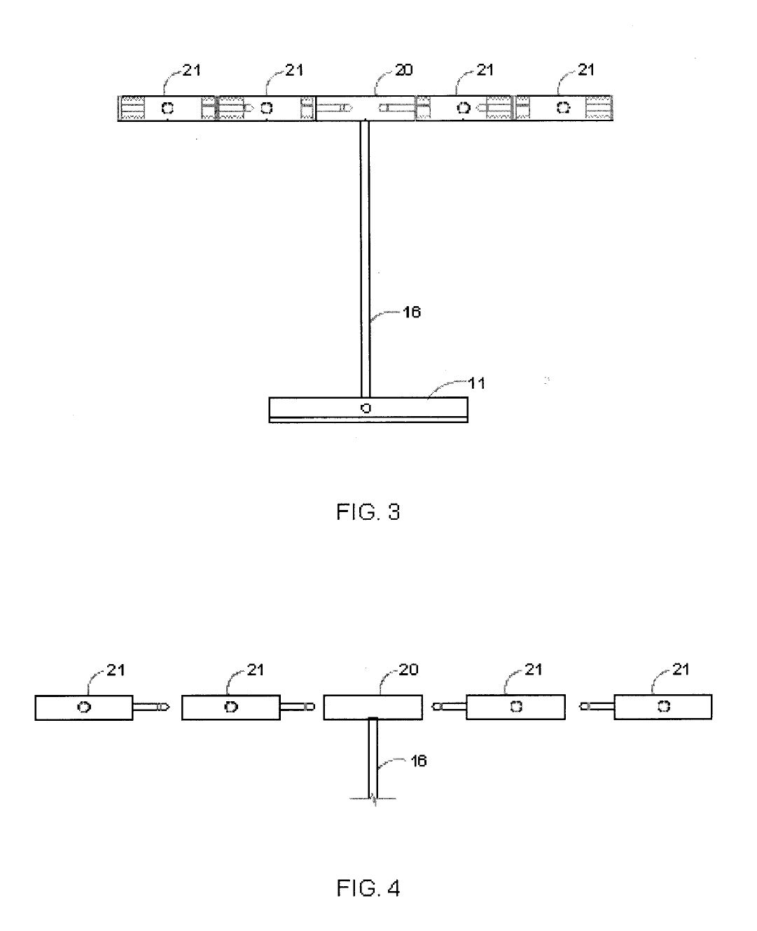

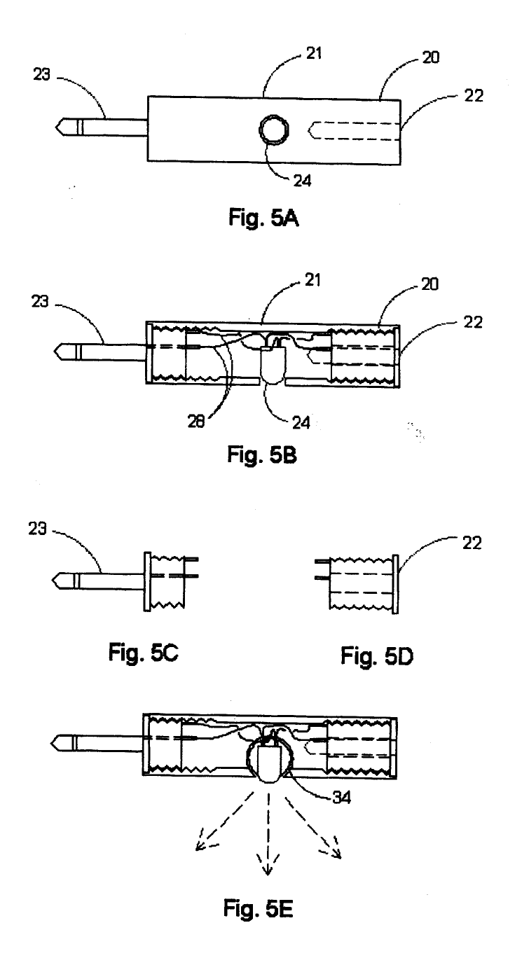

Referring now to FIGS. 1-6 nearer shown a preferred embodiment of the lighting system 10 in accordance with one form of the present invention. The self contained adjustable task lighting system 10 includes a plurality of light emitting diodes or LED's 24 with a rechargeable battery 27. When someone enters a room the light is activated by sound and or motion and the light system 10 will be energized for a pre-set period of time such as 15 minutes. The sensing of sound and/or motion and the energizing of the light emitting diodes 24 for preset time is achieved by a control module 26. The lighting system uses very little energy and may last for months before needing to be re-charged.

The lighting apparatus or system 10 in accordance with the present invention includes several essential parts. These include a starter or base module 19 and one or more snap-in light modules 20. The snap-and light modules 20, in one embodiment, are several inches long and about ½″ to 1″ in diameter. The modules 20, in the preferred embodiment, are cylindrical in shape and contain a male connection fitting or port 23 on one end and a female connection fitting or port 22 on the opposite end. This allows the snap-in modules 20 to connect with one another to form a fixture of any length.

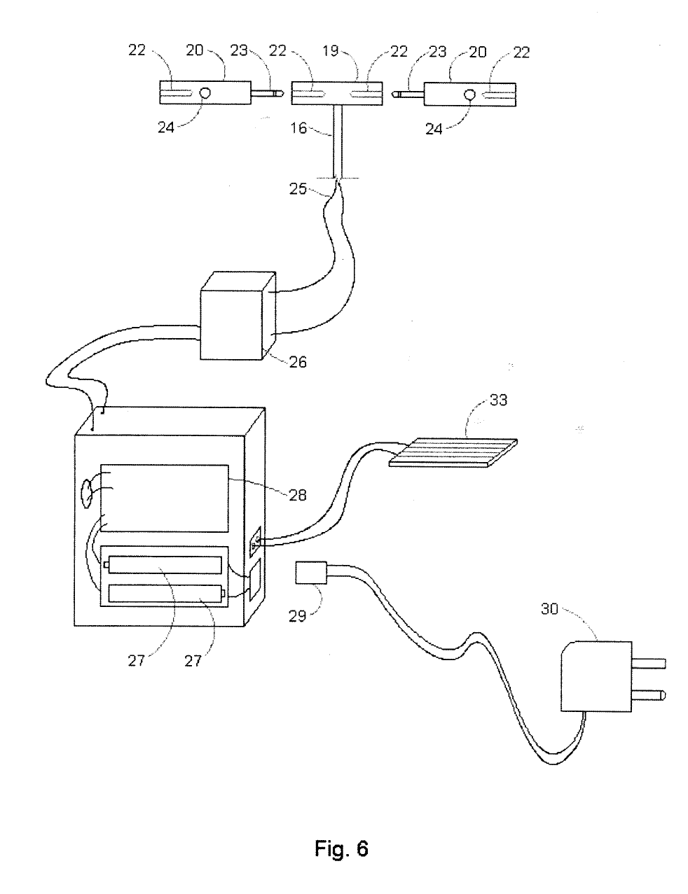

The starting module 19 (best seen in FIG. 6) cooperates with a support bar 16 and a main electrical connection that extends through the support bar 16. The starting module 19 is the elongated and has female connection fittings or ports at each end. This construction allows for symmetrical extensions from the starting module 19 on each of the two axial extremities thereof. Each male and female connection 23, 22 has built in electrical wires to serve one or more light emitting diodes 24 within each snap-in module 20. The male and female connections 23, 22 can be rotated to any angular position in the same manner as the physical connection between an audio speaker jack. More particularly, as in an audio speaker jack, the male connector will include a pin that has axial sections that are electrically insulated from each other. When the snap-in modules 20 are snapped together they form an assembly that locks together for use.

In one form of the present invention the power source for the lights is a 9 volt rechargeable battery 27. Other low voltage power supplies may be used including but not limited to a module designed to plug into a conventional 110 VAC wall connector and produce a DC voltage. The same kind of module is used as a charger 30 in the preferred embodiment of the present invention. Those skilled in the art will recognize that the battery 27 may be replaced by a battery pack comprising more than a single battery and that such a plurality of batteries may be connected in series or in parallel. The battery pack and control circuit may be located under the picture frame 32 or where desired. When the battery pack or battery 27 needs recharging a small battery charger 30 is used to charge the batteries. The light controls may include an “on-off” switch, noise activated control, motion or touch control 26. Switch settings on the control module would allow the user to pre-set the method(s) of control and length of time the lights stay on.

The methods and apparatus in accordance with the present invention have the unique feature of utilizing a plurality of snap-in light modules that can be rotated to any angle. Therefore, any picture can be fitted with picture lighting apparatus in accordance with the present invention and then snap in light modules can be added until the desired lighting effect is obtained. Later, when a new different size picture is desired to be displayed, the same lighting apparatus in accordance with the present invention can be used. The snap-in modules 20 may be added or removed to suit the exact lighting needs.

The apparatus and method in accordance with the president invention allows even an inexperienced art owner to select the proper lighting level and light ray angle across the entire art work by simply adding the snap-in light modules and rotating each module to obtain the ideal lighting for any picture or painting. Especially with oil paintings where the raised paint brush marks greatly influence and the shadow effect of lighting the apparatus and method of the present invention can be used to achieve an adjustment quickly and efficiently. Then, when the picture is replaced with another size frame the same apparatus and method may be used. The snap-in light modules 20 may be added or removed to suit. Then each module 20 can be rotated to then ideal angle. Even after the light angle is adjusted the face of the fixture retains the same outward appearance.

Another application of the present apparatus and method is to illuminate a china cabinet or display case with the same snap-in light modules to provide effective lighting without the need for extension cords and complicated installation. This invention is ideal, for example, for antique dealers that have a display case of select antique products. When a customer approaches the cabinet or display the fixture can be programmed to turn “on” with sound, touch or motion. The customer can then see the item in ideal lighting level without eye strain.

The light emitting diodes (LEDs) 24 may be mounted in a semi round or bullet type holder in the module housing 21. The term “bullet light” will be understood to be a term of the art and to refer to a light having the shape of a cartridge case with a bullet installed therein. This will allow the LED's 24 to swivel in any direction so the light rays can focus on any specific part of the picture. In addition, color lenses and or filters may cover the LED's 24 to enhance the task lighting of each snap-in module 20. Alternatively, there are currently available light emitting diodes that produce red, orange, amber, yellow, green, blue and white light and thus such colored diodes may be used without a lens or filter.

The wall bracket 12 may have mounting holes, for screws 17, for securing the bracket 12 to a wall 31. One hole could be slotted to allow for leveling of the bracket 11. The wall bracket 11, 12 may have a adjustable hook feature that allows the picture frame 32 to be installed slightly below the bracket top 11 and then the adjustment screw of the adjustable hook could be tightened thereby raising the picture frame 32 until it snugly rests against the cushioned underside of the bracket 11.

The wall bracket 11, 12 may have an adjustable hook feature that allows the picture frame 32 to be installed slightly below the bracket top 111 and then the adjustment screw of the adjustable hook could be tightened thereby raising the picture frame 32 until it snugly rests against the cushioned underside of the bracket 11.

The wall bracket 11, 12 may contain a locking feature or accessory that would allow the picture frame to be locked into position so the picture could not be removed without a lock release or key. A locking bracket may be fastened to the picture frame 32 and be locked onto the wall bracket 11, 12. This is particularly suitable where a valuable picture could be stolen.

The LED's consume very little energy and a rechargeable battery 27 may only need charging every several months. Some of embodiments of the present invention include a solar panel 33 strip mounted above the frame. This solar panel 33 would convert any stray sunlight or even some room lighting energy into charging the battery or batteries 27 much like a small calculator. This might eliminate the need for a plug in wall charger 30 in some embodiments.

The lighting apparatus 10 in accordance with the present invention with snap-in modules 20 may be used in many other applications such as cabinet displays and china cabinets. The small diameter modules could be mounted inside an edge of a cabinet and the battery operated LED lighting system would be very helpful for antique display items in a flat or narrow cabinet. The snap-in modules 20 may be of any size or length. For picture lighting the size may be roughly 0.5″ diameter by 1.5″ long. They may be smaller or much larger in diameter, and other lengths, depending on the application. The lights shown as LED's 24 may also be of other low energy consuming types. They may operate at any low voltage and have any size light bulbs to suit the application.

The present invention has been shown and described with respect to the preferred forms of the invention. It will be understood that various embodiments oh of the present invention may include a large number of shapes and sizes:

1. The starter or base module 19 may be curved to a 90 degree angle to allow the lighting apparatus 10 to form a square or rectangle.

2. The starter or base modules 19 may have more than two female connector inserts or ports 22 in order to obtain various shapes.

3. The starter or base module 19 may have a flexible portion for offsets or changes in direction.

4. The starter or base module 19 may be of various diameters, length, voltage, and may contain a LED or other light.

5. The LED 24 may have removable colored lens that can be changed to suit application.

6. The LEDs 24 in the modules may be mounted in a movable base so it can be adjusted in any direction such as a bullet light.

7. The light snap-in modules 20 may be arranged in the corners of an object being illuminated or the corners of a cabinet in which the object being illuminated is disposed. Thus, a position between the top and sides or hidden in china or display cabinets to provide task or focus lighting for the contents is possible.

8. The snap-in modules 20 may be made with lightweight plastic and molded in male and female connectors with built in wiring and an LED for providing low cost task lighting.

### ELEMENT NUMBER LISTING

10. Lighting system
11. Wall bracket—top edge with felt cushion.
12. Wall bracket—back.
13. Bracket for support bar.
14. Friction washer.
15, Tightening washer & fastener—for support bar.
16. Support bar—for light modules.
17. Screws—to secure wall bracket to wall.
18. Adjustable hook—for picture wire support.
19. Starter or base Module.
20. Snap-In Module assembly.
21. Housing shell of module.
22. Female connection or port.
23. Male connection or port.
24. LED.
25. Wires.
26. Control module.
27. Battery.
28. Electronics including battery charger.
29. Charger plug.
30. Charger.
31. Wall.
32. Picture Frame.
33. Solar Panel.
34. Bullet Light.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A lighting fixture which comprises:
a base module having first and second connectors, said connectors been selected from the group that consists of male and female connectors;
at least first and second lighting modules each having male and female connectors, at least one of said connectors on each of said first and second lighting modules being dimensioned and configured for engagement with a connector on said base module, each lighting module including a light emitting diode, each of said male connectors being dimensioned configured for mating engagement with each of said female connectors to provide an electrical connection and a physical mounting limiting relative movement between respective modules having mating connectors.

2. A lighting fixture as described in claim 1 wherein said connectors are dimensioned and configured whereby mating male and female connectors that are part of respective modules allow relative rotation therebetween.

3. A lighting fixture as described in claim 1 wherein said lighting modules are cylindrical.

4. A lighting fixture as described in claim 1 wherein said base module is cylindrical.

5. A lighting fixture as described in claim 1 wherein said lighting module includes a bullet housing.

6. A lighting fixture as described in claim 1 further including a battery for operating one or more light emitting diodes in said lighting modules.

7. A lighting fixture as described in claim 1 further including a rechargeable battery for operating one or more light emitting diodes in said lighting modules.

8. A lighting fixture as described in claim 1 further including a rechargeable battery for operating one or more light emitting diodes in said lighting modules and a solar collector for recharging said rechargeable battery.

9. A lighting fixture as described in claim 1 wherein light from said lighting modules has a color and said color is produced selecting from the group which consists of (1) light emitting diodes that produce colored light and (2) light emitting diodes that produce light that passes through a lens having a color.

10. A lighting fixture as described in claim 1 further including a bracket for engaging a framed artistic work, said bracket supporting said base module and at least first and second lighting modules.

11. A lighting fixture as described in claim 10 wherein said bracket includes a support bar extending to said base module.

12. A lighting fixture as described in claim 11 wherein said bracket is intended for mounting an associated framed artistic work having a mounting wire that is generally horizontal when the artistic work is normally viewed which further includes:
a base;
a hook depending from said base, said hook being mounted to allow movement toward and away from said base whereby said hook can engage the mounting wire and raise the artistic work into engagement with said base.

13. A lighting fixture as described in claim 12 wherein said bracket has a substantially L-shaped form that is dimensioned and configured for engaging the top and back of the associated framed artistic work.

14. A lighting fixture as described in claim 13 further including a locking mechanism to prevent movement of said hook to release the associated mounting wire of the associated artistic work.

15. A lighting fixture as described in claim 14 wherein said bracket includes a plate that is disposed in substantially vertical orientation during normal installation and said plate includes at least two openings for use by associated fasteners to secure said bracket to an associated wall.

16. A lighting fixture as described in claim 15 wary and at least one of said openings is elongated to facilitate leveling of said bracket.

17. A bracket for mounting an associated framed artistic work having a mounting wire that is generally horizontal when the artistic work is normally viewed which includes:
a base;
a hook depending from said base, said hook being mounted to allow movement toward and away from said base whereby said hook can engage the mounting wire and raised the artistic work into engagement with said base.

18. A lighting fixture as described in claim 17 wherein said bracket has a substantially L-shaped form that is dimensioned in configured for engaging the top and back of an associated framed artistic work.

19. A lighting fixture as described in claim 18 further including a locking mechanism to prevent movement of said hook to release the associated mounting wire of the associated artistic work.

20. A lighting fixture as described in claim 19 wherein said bracket includes a plate that is disposed in substantially vertical orientation during normal installation and said plate includes at least two openings for use by associated fasteners to secure said bracket to an associated wall and one of said openings is elongated to facilitate leveling of said bracket.
